(19) United States
(12) Patent Application Publication
(10) Pub. No.: US 2004/0025007 A1
(43) Pub. Date: Feb. 5, 2004

(54) Restricting access to a method in a component

(76) Inventors: Sreekrishna Kotnur, Bangalore (IN); Sasank Kotnur, Bangalore (IN)

Correspondence Address: Indira Saladi, Welsh & Katz, Ltd., 22nd Floor, 120 South Riverside Plaza, Chicago, IL, 60606, US

(21) Appl. No.: 10/208,329

(22) Filed: Jul. 30, 2002

(51) Int. Cl. H04L 9/00; G06F 11/30

(52) U.S. Cl. 713/151; 713/189; 380/277

(57) ABSTRACT

An embodiment of the present invention provides a process and system for restricting access to a method in a distributed computing environment. An embodiment of the invention includes maintaining a list of methods in the distributed commuting environment. Further, the process and system restrict access to a method in the distributed computing environment by generating a key that specifies that the method is blocked and deleting the key when the method is not blocked. An exemplary embodiment includes capability to perform configuration of the system.

### FIELD OF THE INVENTION

This invention relates generally to computer programming, and more particularly to component based development of computer software.

### BACKGROUND

Building better and more efficient software is a goal of software firms. Significant developments have been made to address this goal, which has led to new and easier programming languages, better database systems, and significant improvements in object oriented programming. One such improvement has been the advent of component based development. Component based development generally involves writing or developing small components, where each small component does specific work, and integrating the small components with other small components to form large components or to form an application.

Component based development is prevalent in distributed computing environments where information is shared in, generally, heterogeneous computer networks. For example, many mission-critical computer software applications utilize distributed computing environments to share information. In a distributed computing environment, different components may perform different tasks and the different components may be disbursed over the distributed computing environment. Because the components may be disbursed and located remotely from each other, it may be difficult to control the components.

A problem with distributed computing environments is that quite often a component may behave unpredictably. One cause of such unpredictable behavior oftentimes is that certain methods of the component may create unpredictable behavior. Because of unpredictable behavior, it is desirable to be able to control a component regardless of where in the distributed computing environment the component is located. Further, it is desirable to be able to restrict access to a specific method in a component from at least one other component.

Since components are often employed with distributed computing environments, and the distributed computing environment may include disparate platforms, operating systems and or languages, it is desirable to have a uniform system for restricting access which can be utilized on any platform, with any operating system or accessed regardless of the language used by the application. Accordingly, a need exists for restricting access to a method in a component.

### SUMMARY

An embodiment of the present invention provides a process and system for restricting access to a method in a distributed computing environment. An embodiment of the invention includes maintaining a list of methods in the distributed commuting environment. Further, the process and system restrict access to a method in the distributed computing environment by generating a key that specifies that the method is blocked and deleting the key when the method is not blocked. An exemplary embodiment includes capability to perform configuration of the system.

### BRIEF DESCRIPTION OF THE DRAWINGS

FIG. 1 is a block diagram illustrating the functional blocks of an exemplary embodiment of the invention.

FIG. 1A illustrates an alternative embodiment of a block diagram of the functional blocks.

FIG. 2 illustrates a flow diagram of configuration in accordance with one embodiment of the present invention.

FIG. 3 illustrates a flow diagram of initialization in accordance with one embodiment of the present invention.

FIG. 4 illustrates a flow diagram of placing a block on a method in a publisher component in accordance with one embodiment of the present invention.

FIG. 5 illustrates a flow diagram of removing a block on a method in a publisher component with respect to more than one subscriber component in accordance with one embodiment of the present invention.

FIG. 6 illustrates a flow diagram of removing a block on a plurality of methods in a publisher component with respect to a specific subscriber component in accordance with one embodiment of the present invention.

FIG. 7 illustrates a flow diagram of an alternative embodiment of the present invention where removing a block is based upon a time duration.

FIG. 8 illustrates a flow diagram whereby an application maintains status of methods in accordance with one embodiment of the present invention.

FIG. 9 illustrates a flow diagram of an alternative embodiment of the present invention where a dynamic method container is unavailable.

FIG. 10 illustrates a flow diagram of a deactivation counter in accordance with an embodiment of the present invention.

### DETAILED DESCRIPTION

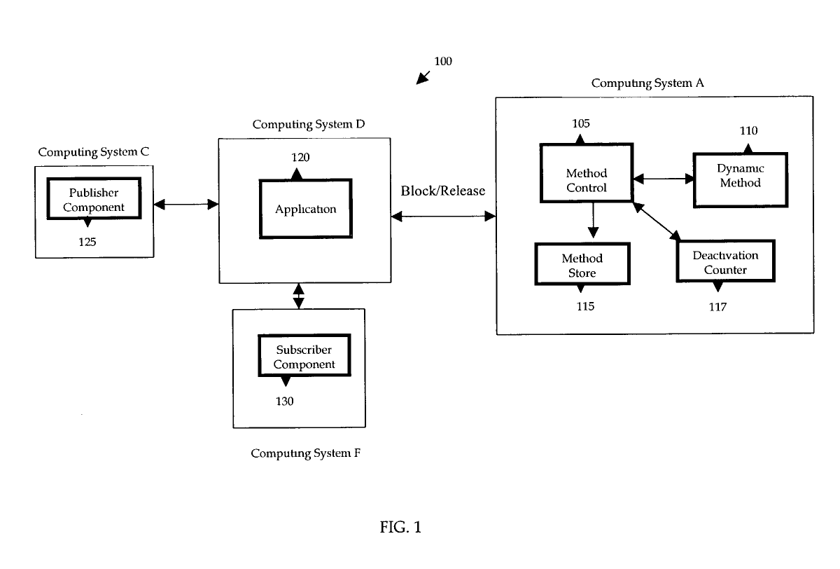

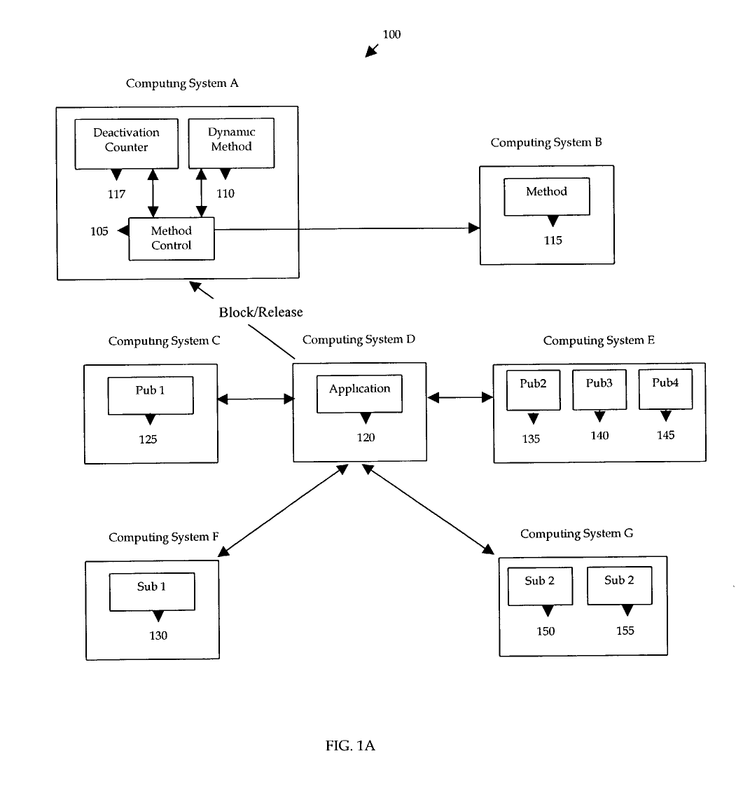

FIG. 1 depicts a block diagram of an exemplary embodiment of a distributed computing environment 100 which may be used to restrict access to (also referred to as “block”) a method in a component from being accessed by another component calling the restricted method. As used herein, the term “method” refers to a software process or procedure that is executed and may, generally, be synonymous with terms, including procedure, function, and routine. Further, the term “component” refers to an object that may have more than one associated method. For example, a method named “TextColor” may function to set color attributes of displayed textual information and “TextColor” may be associated with a component named “GraphicalDisplayAttributes” that has a number of associated methods which perform functions relating to a graphical display.

Shown in FIG. 1 is a distributed computing environment 100 that includes a method control 105, a dynamic method container 110, a method store 115, a deactivation counter 117, an application 120, a publisher component 125, and a subscriber component 130. In an exemplary embodiment, the method control 105, the dynamic method container 110, the deactivation counter 117 and the method store 115 are located on the same computer, e.g. Computing System A. Further, the application 120, the publisher component 125, and the subscriber component 130 are all located on separate computing systems, e.g. Computing Systems D, C, and F, respectively. In an alternate embodiment as shown in FIG. 1A, the method control 105, the dynamic method container 110 and the deactivation counter 117 are located on the same computer and the method store 115 is located on a different computer. In an exemplary embodiment, the deactivation counter 117 is contained with the method control 105, whereas in an alternative embodiment, the deactivation counter 117 is separate from the method control 105.

The placement of the method control 105, the dynamic method container 110, the method store 115, the deactivation counter 117, the application 120, the publisher component 125, and the subscriber component 130 on various computing systems in the distributed computing environment 100 is illustrative and variations of the placement of the method control 105, the dynamic method container 110, the method store 115, the deactivation counter 117, the application 120, the publisher component 125, and the subscriber component 130 will not further be discussed.

An exemplary embodiment of the present invention uses the JAVA programming language and environment. Implementation of an embodiment of the present invention is not restricted to JAVA, as an embodiment of the present invention may be applied to any other programming language by one skilled in the art of programming. Further, implementation of an embodiment of the present invention may be realized by embedded systems programming, e.g. by the use of an application programmer's interface (“API”), such as J2ME, to implement a microprocessor based system. An embodiment of the present invention assumes that a programmer has developed components utilizing conventional programming practices and has compiled the components using generally available compiling tools. Having compiled components, an embodiment of the invention functions to restrict access to a method while an application 120 is executing or as is known in the art, at “runtime.”

As used herein, the term “subscriber component” is used to refer to a component which calls on the methods of another component. For example, in FIG. 1, subscriber component 130 may use the methods of the publisher component 125. The term “publisher component” is used to refer to a component that provides at least one method. For example, as shown in FIG. 1, publisher component 125 may provide methods to various components, including subscriber component 130, in the distributed computing environment 100.

In an exemplary embodiment, the method control 105 functions as a controller to manage access of methods in the distributed computing environment 100. Further, the method control 105 functions as an interface to the application 120 whereby the method control 105 communicates restrictions regarding the methods in the distributed computing environment 100 to the application 120. The method control 105 may also manage access to the subscriber components and publisher components in the distributed computing environment 100.

In an exemplary embodiment, the dynamic method container 110 functions as a data structure. At runtime, the dynamic method container 110 holds information, termed a “key,” regarding restricted methods of the publisher component 125. The information includes, for example, a method name, a publisher component name, any subscriber component names and a release time for each subscriber component, if specified. The dynamic method container 110 provides this information to the method control 105 when the application 120 seeks access to a method in the distributed computing environment 100.

In an exemplary embodiment, the method store 115 functions to store the methods of the publisher component 125. By having a central repository of the methods of the publisher component 125 and where the method control 105 and the method store 115 are located on the same computer system, efficiencies in managing access to the methods of the publisher component 125 may be obtained. For example, time spent querying the publisher component 125 is minimized because the method control 105 does not have to query the publisher component 125 each time the application 120 requests access to a method of the publisher component 125. The method control 105 simply retrieves the methods from the method store 115. Further, communication latency between computing systems in the distributed computing environment may be decreased each time the application 120 requests access to a method of the publisher component 125. In an exemplary embodiment, the method store 115 also functions as a consistent copy of the dynamic method container 110. In such an embodiment, if the method store 115 is unable, the dynamic method container 110 performs the functions of the method store 115.

In an exemplary embodiment, the deactivation counter 117 tracks the methods that need to be released within a specific time-frame, e.g. in the next few minutes, where the term released refers to removing access restrictions on the tracked method. The deactivation counter 117 maintains a list of methods that may need to be released after a specified time duration and constantly checks the time to release each of the methods on the list. If a method is to be released, the deactivation counter 117 prompts the method control 105 to remove access restrictions on the released method. In an alternate embodiment, the deactivation counter 117 generates a thread for every method to be released. In another alternative embodiment, the deactivation counter 117 may be configured to either generate multiple threads for every method to be released or to generate multiple threads for every method to be released.

Shown in FIG. 1 is a subscriber component 130 that calls upon methods in the publisher component 125 where the publisher component 125 is registered with the application 120. In an alternate embodiment, a plurality of subscriber components may call upon methods in a plurality of publisher components where each publisher component is also registered with the application 120. Shown in FIG. 1A is an example of an embodiment where the plurality of subscriber components 130, 150, 155 are located on separate computing systems and call upon methods in a plurality of publisher components 125, 135, 140, 145 where the publisher components are also located on separate computing systems.

In operation, an exemplary embodiment of the invention restricts access to a method in a component from being accessed by another component calling the restricted method by (a) maintaining a list of methods in the distributed programming environment 100, (b) restricting access to a method in the list of methods in the distributed programming environment 100 by generating a key which specifies that the method is blocked, and (c) deleting the key when the method is not blocked. An exemplary embodiment of the present invention may further include the step of configuring data structures. An exemplary embodiment of the present invention may further include the step of maintaining a status of the methods of a component.

The step of maintaining a list of methods in the distributed programming environment 100 functions to provide notice to the application 120 of the methods available by the publisher components. In an exemplary embodiment, the function of maintaining a list of methods is provided by a persistent storage object, e.g. the method store 115 shown in FIGS. 1 and 1A. Further, the function of maintaining a list of methods may also be provided by dynamic storage object, such as the dynamic method container 110 shown in FIGS. 1 and 1A.

The step of restricting access to a method in the list of methods in the distributed programming environment 100 by generating a key which specifies that the method is blocked functions to enable the blocking of methods provided by publisher components. In an exemplary embodiment, the function of restricting access to a method may be provided by a processor which manages access to a method in the distributed programming environment 100, such as the method control 110 shown in FIGS. 1 and 1A.

The step of deleting the key when the method is not blocked functions to remove restrictions regarding access to the method. In an exemplary embodiment, the function of deleting the key may be provided by a processor which allows access to a method in the distributed programming environment 100, such as the method control 110 shown in FIGS. 1 and 1A.

In an alternative embodiment, the invention further includes the step of configuring data structures. The step of configuring data structures functions to enable the invention to be customizable and configurable. Such a step may be performed before run-time, at the beginning of run-time, or at any time that the application 120 desires to perform custom configuration of data structures.

The step of maintaining status of the methods of a component functions to enable an application to determine the accessibility to requested methods and requires that a process periodically update the list of methods so that the list of methods provides an accurate indication of blocked methods in the distributed computing environment 100.

The step of configuring data structures may include a configuration utility whereby configuration parameters regarding operation of an embodiment of the present invention is accomplished. Specifically, the configuration utility may allow the application 120 to set configuration parameters including a trigger time, default block duration, event notification, log notification, response time, and poll value. In an exemplary embodiment of the present invention, the trigger time is a time when the method control 105 parses the dynamic method container 110 to determine whether blocked methods are to be released; the default block duration is a default time that a method is blocked when a method does not have a specified block duration; event notification is a binary value which when set requires the method control 105 to notify the application 120 before a blocked method 120 is to be released; log notification is a binary value which when set logs events; response time specifies a specific period of time to wait for a response from the application 120 after notifying the application 120 of a release event; and a poll value specifies the frequency at which the deactivation counter 117 checks the system time to release blocked methods.

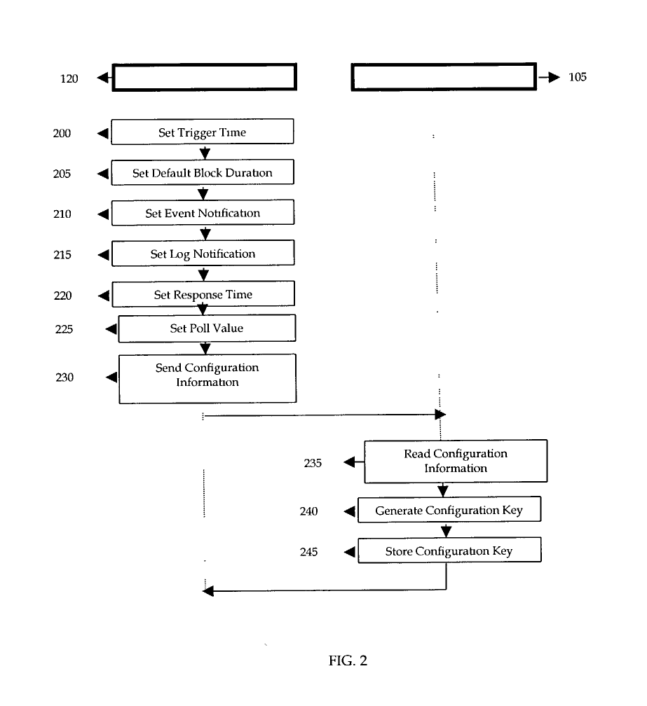

As shown in FIG. 2, in an exemplary embodiment, the application 120 sets the trigger time 200. The application 120 then sets the default block duration 205. The application then may set event notification 210. Notifying the application 120 of a release event before it occurs enables the application 120 to decide whether or not to extend the duration of the blocked method. Further, the application may then set log notification 215. Setting log notification keeps a history of events such as the application 120 requesting a blocked method, release event of a blocked method, and setting of configuration parameters. Further shown in FIG. 2, the application 120 sets the response time 220. If the application 120 does not respond within the response time, the method control 105 releases the blocked method. Then the application 120 may set a Poll Value 225. In an alternate embodiment, the Poll Value is preset to an initial value, e.g. 30 microseconds. Configuration concludes when the application 120 sends 230 the configuration information to the method control 105. The method control 105 receives and reads the configuration information 235 received from the application 120. Based upon the received configuration information, the method control 105 generates a configuration key 240 and stores the key 245 in the method store 115. The configuration key 240 serves as security against alterations to the method control 105 and is needed whenever changes to the method control 105 are made.

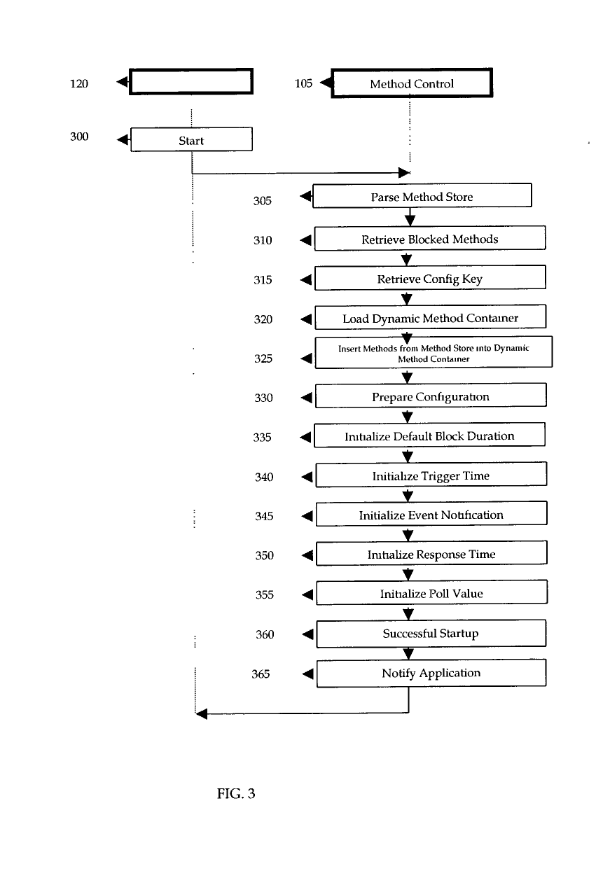

As illustrated in FIG. 3, an exemplary embodiment of the present invention includes a startup sequence whereby startup begins by the application 120 calling upon 300 the method control 105. The method control 105 then parses 305 the method store 115 and retrieves the blocked methods 310. The method control 105 then retrieves the configuration key 315 from the method store 115. The method control 105 then loads 320 the dynamic method container 110 and inserts the blocked methods 325 in the dynamic method container 110. The method control 105 then extracts the configuration key from the method store 115. Based upon the details of the configuration key, the method control 105 initializes the default block duration value 335, the trigger time value 340, the event notification value 345, the response time value 350, and the poll value 355.

On successful startup 360 the method control 105 notifies 365 the application 120 of the successful startup. In an alternative embodiment of the present invention, if initialization of the method control 105 fails, then notification of the failed initialization is communicated to a user. In yet another alternative embodiment, if initialization of the method control 105 fails, then notification of the failed initialization is communicated to the application 120 via an appropriate exception. In an exemplary embodiment, if the method control 105 initializes and the method store 115 is unable, then an alternate method store may be provided and the method control 105 may retrieve the list of methods from the alternate method store. The alternate method store may be a copy of the method store 115 and may be located on a fault tolerant computing system in the distributed computing system. If the configuration key is not found from either the method store 115 or the alternate method store, then the method control 105 may begin with a default configuration which may be preset in an embodiment of the invention.

In an embodiment of the present invention, the application 120 may handle errors received from the method control 105 by performing actions including restarting the application 120, handling the error via appropriate error handling software, and spooling until the method control 105 is able to handle requests from the application 120. As is known in the art, any number of error handling derivatives may be accommodated by the application 120 and will not be further discussed.

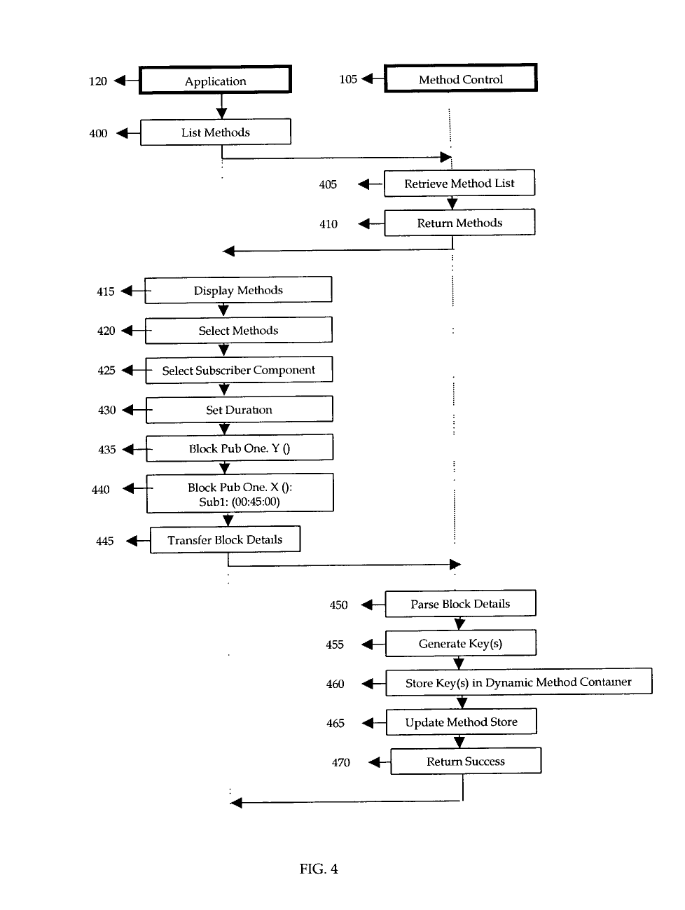

Shown in FIG. 4 is an example of a subscriber component being restricted from accessing a blocked method. In order to restrict a subscriber component from calling on a method of a publisher component, the application 120 calls 400 the method control 105 to list methods in the distributed computing environment 100. The method control 105 then retrieves the list of methods 405 from the method store 115 and returns the list of methods 410 to the application 120. The application 120 selects a method to be blocked 420 from the list of methods. The application selects a subscriber component 425 and sets the duration for restricting access to the blocked method by the subscriber component 430.

For example, an exemplary embodiment of restricting access by specific subscriber components from a method of a publisher component is performed by executing the following object:

PubOne.add( ).SubOne.(12:45:45).SubTwo.(14:32:00).SubThree.(21:00:00)

In this example, a publisher component named “PubOne,” has a method “add( )” blocked from being accessed by subscriber components named “SubOne,” “SubTwo,” and “SubThree” for specific durations to be released at the times specified. For example, subscriber component “SubOne” will be released from the restriction to accessing “add( )” at a time 12:45:45.

For another example, an exemplary embodiment of restricting access by a plurality of subscriber components from a method of a publisher component is performed by executing the following object:

PubTwo.mul( ).(18:30:00)

In this example, a publisher component named “PubTwo” has blocked its method “mul( )” from being accessed by any subscriber component requesting access to the method. Access to the method is blocked for a specific duration and is scheduled to be released at a time 18:30:00. In such an example, a method can be blocked from being accessed by a plurality of subscriber components including all the subscriber components in the distributed computing environment.

In yet another example, an exemplary embodiment of restricting access by a subscriber component from a method of a publisher component for two specific durations is performed by executing the following object:

PubOne.add( ).SubOne.(12:45:45).(18:00:00)

In the above example, a publisher component named “PubOne” has blocked its method “add( )” from being accessed by subscriber component “SubOne” at multiple instances of time. The above object allows the method “add( )” to be released at a first instance of time of 12:45:45 and at a second instance of time 18:00:00. As the invention can be scheduled to block a method the method control only needs to include the release duration(s)] In an exemplary embodiment, blocking access to the method “add( )” may be performed at any time after the block is released, e.g. 12:45:45 in the above example. By specifying a block for multiple times, regeneration of the key is not necessary.

In yet another example, a specific subscriber component may be blocked from accessing a method without having to explicitly specify the duration of the block 435. In an exemplary embodiment, a block is performed without having to specify a start time.

In an exemplary embodiment, the application 120 transfers information regarding the block to the method control 105 where the information includes the publisher component name, name of the method to be blocked, the subscriber component names and the release time for each of the subscriber components of the block 445 to the method control 105. On receiving the information regarding the block, the method control 105 processes the information 450 specified and generates 455 a method key. The method key encapsulates the information regarding the blocked method. In an alternate embodiment, when a plurality of components are chosen to be restricted from accessing a plurality of methods of a component, the method control 105 generates a separate method key for each blocked method.

In an exemplary embodiment, the method control 105 stores the method keys 460 in the dynamic method container 110 and updates the method store 115 with the method keys 465. In an exemplary embodiment, on successfully storing the method key in the dynamic method container 110 and the method store 115, the method control 105 returns a message 470 to the application 120 indicating that the assigned task of blocking has been performed successfully.

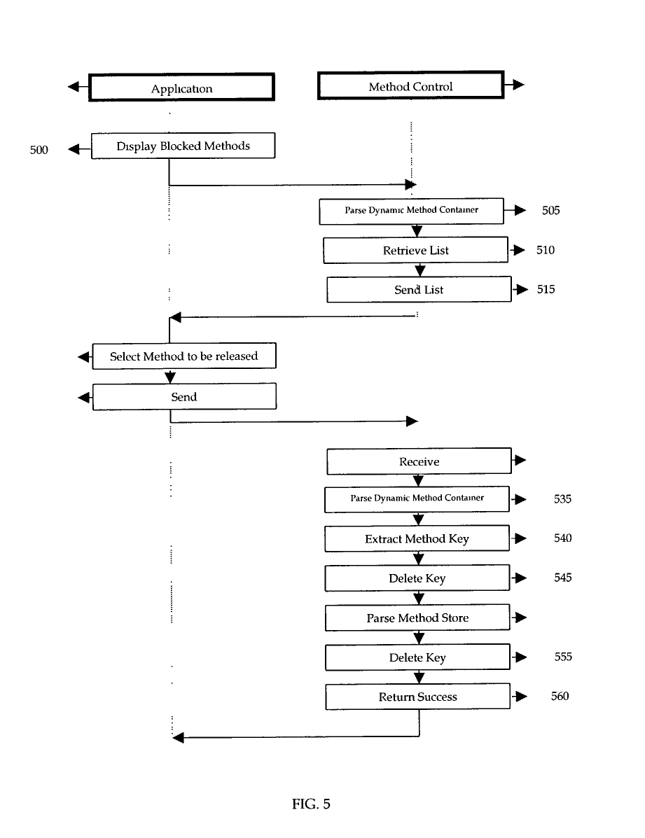

As illustrated in FIG. 5, releasing a blocked method is similar to placing a restriction on a method to be blocked. In an exemplary embodiment of the invention, to release more than one instance of a subscriber component from being blocked from accessing a particular method, the application 120 initially requests a list of blocked methods from the method control 500. To get a list of blocked methods, the method control parses 505 the dynamic method container 110 to retrieve 510 the list of blocked methods. The method control 105 then sends the list of the blocked methods 515 to the application 120. In an exemplary embodiment, the application 120, selects the method 520, which is to be released and the request is sent 525 to the method control 105 to release the selected method. In an exemplary embodiment, on receiving 530 the request to release a method from the application 120, the method control 105 parses 535 the dynamic method container 110, extracts the method key of the selected method 540, and deletes 545 the method key of the selected method from the dynamic method container 110. The method control 105 then parses 550 the method store 115 and deletes the method key of the selected method 555 from the method store 115. Deleting the method key of the selected method from the method store 115 deletes information in the method key of the selected method and results in releasing the block on the selected method with respect to every instance of a subscriber component calling the selected method. In an exemplary embodiment, the method control subsequently returns a message 560 to the application 120 on successful completion of releasing the blocked method.

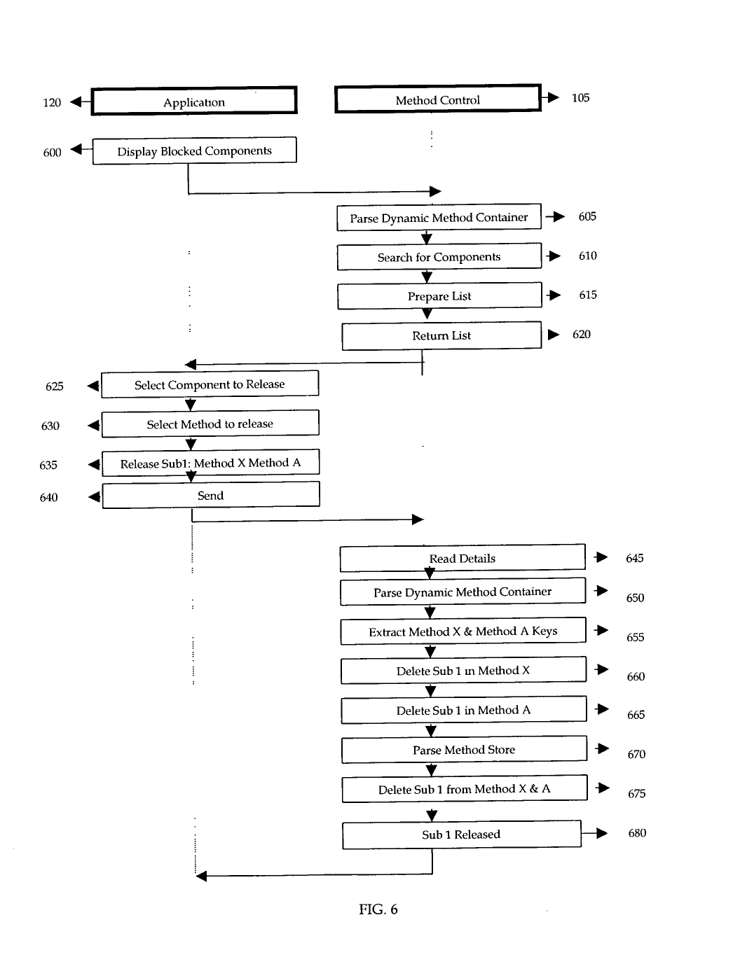

In an alternate embodiment, a plurality of blocked methods are released with respect to subscriber components. Illustrated in FIG. 6 is an exemplary flow diagram to remove restrictions on a subscriber component when the subscriber component is restricted from accessing a plurality of methods of a publisher component. In an alternate embodiment, the application 120 may remove restrictions on a plurality of subscriber components that are restricted from accessing a plurality of methods of a publisher component. In either case, the application 120 requests the method control 105 to display 600 the list of methods that are blocked with respect to a subscriber component and the method control 105 parses 605 the dynamic method container 110 to search 610 for methods that are blocked from being accessed by the subscriber component.

In an exemplary embodiment of the invention, the application 120 selects the subscriber component 625 to be released and selects the methods that need to be released for the selected subscriber component 630, 635. The application 120 sends the release details 640 to the method control 105. The method control 105 reads the details 645 received from the application 120, parses 650 the dynamic method container 110, and extracts the method keys 655 of the methods which are to be released with respect to the selected subscriber component. The method control 105 then deletes method keys 660, 665 of the subscriber component of the selected methods. The method control 105 then parses 670 the method store 115 and deletes the method keys 675 of the subscriber component, e.g. ‘sub 1,’ in the method store 115. The method control 105, on completion of this task informs 680 the application 120 of the successful completion of the task of releasing the restrictions on a subscriber component from accessing methods of the publisher component. To remove restrictions relating to a plurality of subscriber components, the method control 105 deletes method keys with respect to each subscriber component requiring access to the blocked methods.

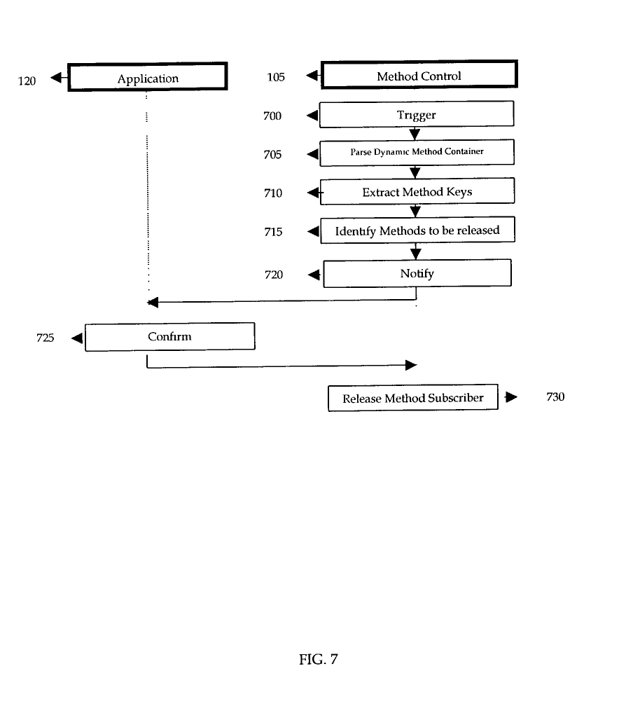

As illustrated in FIG. 7, in an exemplary embodiment of the invention, the method control 105 is configured to release one or a plurality of blocked methods in a publisher component at expiration of a block time for one or a plurality of methods with respect to a subscriber component. In an alternate embodiment, the method control 105 is configured to release one or a plurality of blocked methods in a publisher component at expiration of a block time for one or a plurality of methods with respect to a plurality of subscriber components.

In an exemplary embodiment of the invention, when a trigger is initiated 700, the method control 105 parses 705 the dynamic method container 110 and extracts the method keys 710 from the dynamic method container 110 and reads a duration parameter in the method keys to identify 715 which methods and what time each method is scheduled for release. The method control 105 prepares a list of methods that will be released shortly, e.g. within a time frame of five minutes, and notifies 720 the application 120. The method control 105 receives a confirmation 725 from the application 120 and releases 730 the selected method or a plurality of selected methods. The release sequence is as described in FIG. 6.

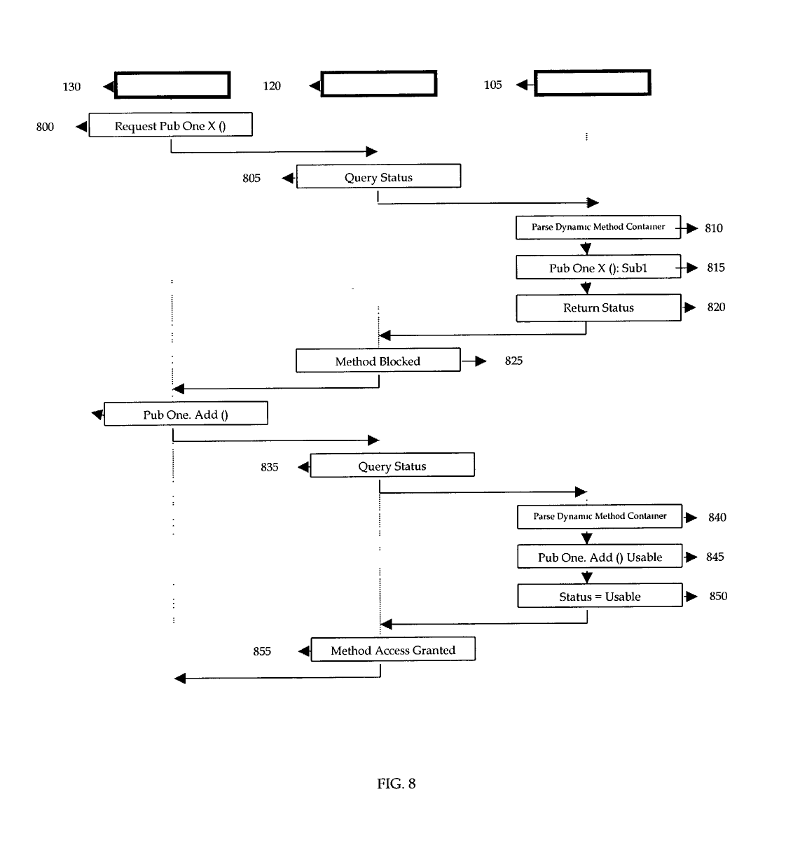

As illustrated in FIG. 8, in an exemplary embodiment of the invention, the application 120 restricts a subscriber component from accessing a method in a publisher component depending on whether the method has been blocked with respect the subscriber component. If the application 120 does not restrict a subscriber component from accessing a method in a publisher component, then the application 120 allows access to the method in the publisher component with respect to the unrestricted subscriber component. In an alternate embodiment, the application 120 restricts a subscriber component from accessing a plurality of methods in a publisher component, depending on whether such methods have been blocked with respect to such subscriber components. If the application 120 does not restrict the subscriber component from accessing the plurality of methods in the publisher component, then the application 120 allows access to the methods in the component with respect to the unrestricted subscriber components.

As illustrated in FIG. 8, in an exemplary embodiment, when a subscriber component 130 requests 800 the application 120 for access to a method. The application 120 queries 805 the method control 105 to determine whether the subscriber component 130 can access the requested method. The method control 105 then parses 810 the dynamic method container 110 to check access restrictions on the requested method, which is requested by the subscriber component 130. The method control may determine that the requesting subscriber component 130 is blocked from access by the requested method and may subsequently notify the application 120 that the requesting subscriber component is blocked from accessing the requested method. Notifying is performed by returning a status 820 (e.g. whether the requested method is blocked for the requesting subscriber component or if the method is blocked for all subscriber components) to the application 120. In an exemplary embodiment, if the status is that the requested method is blocked, the application 120 will not process the request of the subscriber component as the method is blocked from being used. If the application 120 is notified that the method being requested is currently blocked, then the application 120 returns a message to the subscriber component calling the blocked method.

In an exemplary embodiment of the invention, when a subscriber component 130 requests 830 the application 120 for access to a method, the application 120 queries 835 the method control 105 to determine whether the requesting subscriber component 130 can access the requested method. The Method control parses the dynamic method container 840 to determine whether the requesting subscriber component has access to the requested method. The determination is termed a “status” and information is sent to the application 120 by the method control 850. If the requesting subscriber component has access to the requested method, the application processes the request. If the application 120 is notified that the method being requested is currently blocked form being used, then the application returns a message to the subscriber component requesting the blocked method.

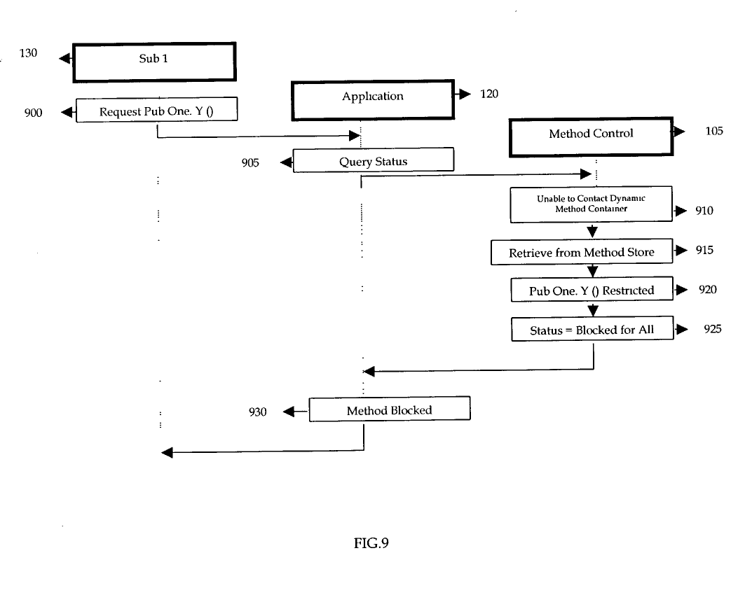

As illustrated in FIG. 9, in an exemplary embodiment of the invention, if the method control 105 fails to retrieve information regarding blocked methods from the dynamic method container 110, e.g. because the dynamic method container 110 is not active or fails to respond, the method control 105 may still be able to process requests from the application 120. If the method control is unable to contact 910 the dynamic method container 110 to check the details of the access restrictions on the requested method, the method control 105 retrieves details 915 of access restrictions on the requested method from the method store 115. The method control 105 retrieves status information regarding access to the requested method from the method store 115 and the method control 105 sends the status information 925 to the application 120. In turn, the application 120 sends the status information to the requesting subscriber component 130.

Alternate embodiments of the invention include a plurality of dynamic method containers where the dynamic method containers may be remotely located and distributed on heterogeneous computing environments.

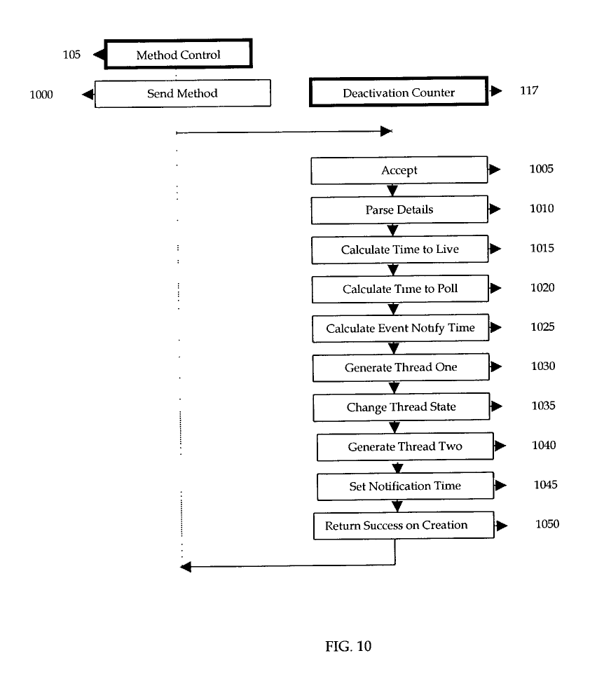

As illustrated in FIG. 10, the method control 105 sends details of the methods 1000 that need to be released before the next trigger time to the deactivation counter 117. The deactivation counter receives 1005 the Method Details and parses it 1010. The deactivation counter calculates the Time to Live 1015 for the Blockage, the Time to Poll 1020, and the Event Notification Time 1025. It then generates a thread to contain all the details of the various methods to be released 1030 and changes the state of the thread from active to sleep 1035. The deactivation counter generates another thread 1040 and sets the thread to notify 1045 the method control before the release of the blocked method. The deactivation counter then updates the method control 1050.

While various embodiments of the invention have been described, it will be apparent to those of ordinary skill in the art that many more embodiments and implementations are possible that are within the scope of this invention.

1. A process for restricting access to a method in a distributed computing environment, the process comprising the steps of:
(a) maintaining a list of methods in the distributed commuting environment;
(b) restricting access to a method in the list of methods in the distributed computing environment by generating a key which specifies that the method is blocked; and
(c) deleting the key when the method is not blocked.

2. The process of claim 1 wherein the method is associated with a publisher component.

3. The process of claim 1 further comprising configuring at least one data structure where the data structure maintains configuration information relating to the process.

4. The process of claim 1 further comprising the step of initializing whereby startup information, including the list of methods and a configuration key, is retrieved from a method store and copied to a dynamic method container.

5. The process of claim 1 wherein the method in the list of methods refers to software of a publisher component in the distributed computing environment.

6. The process of claim 1 wherein the step of restricting access further comprises blocking a subscriber component in the distributed computing environment from executing the method in the list of methods.

7. The process of claim 1 wherein the step of restricting access further comprises parsing a dynamic method container to retrieve information relating to the list of methods.

8. The process of claim 1 wherein the step of maintaining further comprises the steps of:
(a) retrieving the key at a predetermined trigger time; and
(b) releasing access to the method at an expiration of a predetermined response time.

9. The process of claim 8 wherein a configuration utility sets parameters including the predetermined trigger time and the predetermined response time.

10. The process of claim 1 wherein the key is information including a method name, a publisher component name, at least one subscriber component name, and a release time for the at least one subscriber component.

11. The process of claim 1 further comprising the step of maintaining a status of the methods in the distributed programming environment.

12. The process of claim 1 wherein at least one subscriber component is restricted from accessing the method in the list of methods.

13. The process of claim 1 wherein a method control removes the key from the distributed computing environment when the step of restricting access to the method is no longer required.

14. The process of claim 1 wherein the step of maintaining a list is performed on a computer different than the step of restricting access.

15. The process of claim 1 wherein the list of methods is stored in a persistent memory.

16. The process of claim 1 wherein the step of maintaining a list is programmed in a language different than the step of restricting access.

17. The process of claim 1 wherein the step of maintaining a list further comprises the step of managing information relating to at least one subscriber component blocked from accessing the method.

18. The process of claim 17 wherein the information includes a name of the at least one subscriber component, a block duration, and a method name.

19. The process of claim 1 wherein the step of deleting the key occurs at a predetermined time.

20. The process of claim 1 wherein the step of deleting the key occurs at a periodic interval of time.

21. The process of claim 1 further comprising the step of notifying an application with information that the step of restricting access is taking place.

22. The process of claim 1 further comprising the step of recording transactions in the distributed computing environment.

23. The process of claim 22 wherein transactions include requesting the method, deleting the key, setting of configuration parameters, and restricting access.

24. The process of claim 1 further comprising:
(a) notifying an application before performing the step of deleting the key; and
(b) extending the step of restricting access until the application requires that the step of deleting the key be performed.

25. The process of claim 1 wherein the step of maintaining further comprises monitoring a block duration parameter of the key to determine when a block should be released.

26. A process for restricting access to a method in a distributed computing environment, the process comprising the steps of:
(a) maintaining a list of methods in the distributed commuting environment;
(b) blocking at least one subscriber component of access to least one method in the list of methods in the distributed computing environment by generating a key associated with the at least one method which specifies that the at least one method is blocked from being accessed by the at least one subscriber component; and
(c) monitoring a duration parameter of the associated key to determine when to modify the associated key so as to provide access to the method to the at least one subscriber component.

27. The process of claim 26 further comprising the step of retrieving a list of blocked methods associated with the at least one subscriber component.

28. A system for restricting access to a method in a distributed computing environment, the system comprising:
(a) a method control which manages access to the method by at least one subscriber component in the distributed computing environment; and
(b) at least one dynamic method container to hold information relating to the method and the at least one subscriber component, and to further include a key relating to access of the method by the at least one subscriber component,
wherein the method control retrieves the key relating to access of the method from the at least one dynamic method container to determine whether to provide access to the method to an application requesting access to the method.

29. The system of claim 28 wherein the method is associated with a publisher component.

30. The system of claim 28 further comprising at least one method store which maintains a list of methods in the distributed programming environment.

31. The system of claim 30 wherein the key is stored in the at least one method store if the at least one dynamic method container is unavailable to the method control.

32. The system of claim 31 wherein the method control interfaces with the at least one method store.

33. The system of claim 31 wherein the method control and the method store are located on separate computers.

34. The system of claim 28 further comprising a deactivation counter that monitors duration of time that restricting access to the method occurs.

35. The system of claim 28 where the method control, the application, the at least one subscriber component, and the method are located on separate computing systems.

36. The system of claim 28 where the method control, the application, the at least one subscriber component, and the method are developed in different programming languages.

37. The system of claim 28 where the method and the at least one subscriber component are located on separate computing systems.

38. The system of claim 28 where the method control interfaces with the application that requests access to the method in the distributed computing system.

39. The system of claim 28 where the method control is a processor based computing system.

40. The system of claim 28 wherein the key is information including a method name, a publisher component name, at least one subscriber component name, and a release time for the at least one subscriber component.

41. The system of claim 40 wherein the publisher component name refers to an object which is available to be used by at least one component in the distributed computing environment, including the application and the at least one subscriber component.

42. The system of claim 40 wherein the at least one subscriber component name refers to an object which calls on at least one component in the distributed computing environment, including the application and the method.

43. The system of claim 28 wherein the method control retrieves a list of methods in the distributed computing environment.

44. The system of claim 28 wherein the method control manages access to at least one method by at least on subscriber component in the distributed computing environment.

45. A system for restricting access to a method in a distributed computing environment, the process comprising:
(a) means for maintaining a list of methods in the distributed commuting environment;
(b) means for restricting access to a method in the list of methods in the distributed computing environment by generating a key which specifies that the method is blocked; and
(c) means for deleting the key when the method is not blocked.
